(19) United States
(12) Patent Application Publication
(10) Pub. No.: US 2011/0219194 A1
(43) Pub. Date: Sep. 8, 2011

(54) DATA RELAYING APPARATUS AND METHOD FOR RELAYING DATA BETWEEN DATA

(75) Inventor: Toshiharu Okada, Tokyo (JP)

(73) Assignee: OKI SEMICONUCTOR CO., LTD., Tokyo (JP)

(21) Appl. No.: 13/036,128

(22) Filed: Feb. 28, 2011

(30) Foreign Application Priority Data
Mar. 3, 2010 (JP) 2010-046704

(51) Int. Cl. G06F 12/08

(52) U.S. Cl. 711/137; 711/E12.057

(57) ABSTRACT

A data relaying apparatus and method capable of relaying data in a highly efficient manner. Data of a predetermined read-ahead size is acquired from the storage apparatus from a top address indicated by a data read request to temporarily store the data as temporary storage data and, each time a subsequent data read request is made, data of a transmission data size corresponding to a type of the subsequent data read request is read out sequentially from a top position of the temporary storage data to relay the data to a data processing apparatus.

### BACKGROUND OF THE INVENTION

1. Field of the Invention

The present invention relates to a data relaying apparatus and method for relaying data between data buses.

2. Description of the Related Art

In a server or personal computer for example, data may be transmitted/received between two buses having specifications different from each other. FIG. 1 is a block diagram of a conventional data relaying apparatus 210 such as a hub that relays data between a local bus 230 and a PCI-Express bus 250, and also depicts a CPU 220 and a memory 240. The data relaying apparatus 210 executes a write relaying process of relaying a write request and write data from the CPU 220 to the memory 240, and a read relaying process of relaying a read request from the CPU 220 to the memory 240 and relaying read data from the memory 240 to the CPU 220. For example, an apparatus transmitting/receiving data via a PCI-Express bus is disclosed in Japanese Patent Kokai No. 2009-267771.

FIG. 2 is a sequence diagram of data transmission/reception in the write relaying process by the data relaying apparatus 210. For each arrival of a write request (“REQUEST” in FIG. 2) and data corresponding to the request from the CPU 220, the data relaying apparatus 210 relays the request and the data to the memory 240 (steps S901 to S906). The memory transmits an ACK signal as a notification of the reception of the data to the data relaying apparatus 210 (S907 and S908).

FIG. 3 is a sequence diagram of data transmission/reception in the read relaying process by the data relaying apparatus 210. After relaying a read request (“REQUEST” in FIG. 3) from the CPU 220 to the memory 240 (S911 and S912), the data relaying apparatus 210 waits for the arrival of the read data corresponding to the request from the memory 240. The data relaying apparatus 210 subsequently relays the read data from the memory 240 to the CPU 220 and returns ACK to the memory 240 (S913 and S914). After the data corresponding to the read request (step S911) is received (step S914), the CPU 220 issues a read request (step S921) for subsequent data to the data relaying apparatus 210. The data relaying apparatus 210 executes the same process in response to a subsequent read request (S921 to S944).

### SUMMARY OF THE INVENTION

As depicted in FIG. 2, when a write process is executed, the data relaying apparatus 210 sequentially relays the write requests and the data corresponding to the requests from the CPU 220 to the memory 240 and, therefore, no extra time (so-called overhead) is created for writing.

In contrast, as depicted in FIG. 3, when a read process is executed, the data relaying apparatus 210 waits for the arrival of the read data from the memory 240 each time the CPU 220 issues a read request and, therefore, for example, if four consecutive read processes 1 to 4 are executed (S911 to S944), a considerable time is problematically required. For example, if 1024-byte data is read out by one byte, since a read request from the CPU 220 is transmitted 1024 times over the local bus 230, the extra time (so-called overhead) for reading is equal to a time of a period until the transmission of data from the memory 240 (e.g., period of S912 to S913)×1024. If a subsequent read request is issued before the arrival of the read data, the read data arrives one after another before the data relaying apparatus 210 processes the data already read and complicates the data process and, therefore, the data relaying apparatus 210 issues a subsequent read request after waiting for the arrival of the read data.

The present invention has been made in view of the above problems and it is therefore an object of the present invention to provide a data relaying apparatus and method capable of relaying data in a highly efficient manner even in a communication form in which an apparatus on the read request side receives data corresponding to a read request before issuing a read request for subsequent data.

According to a first aspect of the present invention there is provided a data relaying apparatus having a relaying part that acquires data stored in a storage apparatus via a second data bus in response to a data read request arriving from a data processing apparatus via a first data bus to relay the data to the data processing apparatus via the first data bus, comprising a temporary storage part that acquires data of a predetermined read-ahead size from the storage apparatus from a top address indicated by the data read request to temporarily store the data as temporary storage data, wherein each time a subsequent data read request is made, the relaying part reads out data of a transmission data size corresponding to a type of the subsequent data read request sequentially from a top position of the temporary storage data to relay the data to the data processing apparatus.

According to a second aspect of the present invention there is provided a data relaying method having a relaying step of acquiring data stored in a storage apparatus via a second data bus in response to a data read request arriving from a data processing apparatus via a first data bus to relay the data to the data processing apparatus via the first data bus, comprising a temporary storage step of acquiring data of a predetermined read-ahead size from the storage apparatus from a top address indicated by the data read request to temporarily store the data as temporary storage data, wherein at the relaying step, each time a data request is made, data of a transmission data size corresponding to a type of the data request is relayed sequentially from a top position of the temporary storage data to the data processing apparatus.

According to a data relaying apparatus and method of the present invention, data may be relayed in a highly efficient manner even in a communication form including an apparatus on the read request side that receives data corresponding to a read request before issuing a read request for subsequent data.

### BRIEF DESCRIPTION OF THE DRAWINGS

FIG. 1 is a block diagram of a conventional data relaying apparatus;

FIG. 2 is a sequence diagram of data transmission/reception in a write relaying process by the data relaying apparatus of FIG. 1;

FIG. 3 is a sequence diagram of data transmission/reception in a read relaying process by the data relaying apparatus of FIG. 1;

FIG. 4 is a block diagram of a data relaying apparatus of a first embodiment depicted along with blocks of CPU etc.;

FIG. 5 is a flowchart of a read relaying process routine;

FIG. 6 is a sequence diagram of data transmission/reception in the read relaying process of FIG. 5;

FIG. 7 is a block diagram of a data relaying apparatus of a second embodiment depicted along with blocks of CPU etc.;

FIG. 8 is a flowchart of a read-ahead size setting process routine;

FIG. 9A is a sequence diagram of data transmission/reception in the read relaying process when a read-ahead size is set to a read-ahead maximum size in the routine of FIG. 8;

FIG. 9B is a sequence diagram of data transmission/reception in the read relaying process when a read-ahead size is set in accordance with a request dependent size in the same routine;

FIG. 10 is a sequence diagram of data transmission/reception in the read relaying process when 512-byte data is read out in the case of the read-ahead maximum size set to 256 bytes;

FIG. 11 is a sequence diagram of data transmission/reception in the read relaying process when 512-byte data is read out in the case of the read-ahead maximum size set to 512 bytes;

FIG. 12 is a block diagram of a data relaying apparatus of a third embodiment depicted along with blocks of CPU etc.;

FIG. 13 is a diagram of a size correlation table representing correlation between a protocol type and a read ahead data size;

FIG. 14 is a flowchart of a read-ahead maximum size setting process routine;

FIG. 15A is a sequence diagram of data transmission/reception in the read relaying process when an acquisition size larger than a currently set size is set as the read-ahead maximum size in the routine of FIG. 14; and

FIG. 15B is a sequence diagram of data transmission/reception in the read relaying process when an acquisition size smaller than a currently set size is set as the read-ahead maximum size in the same routine.

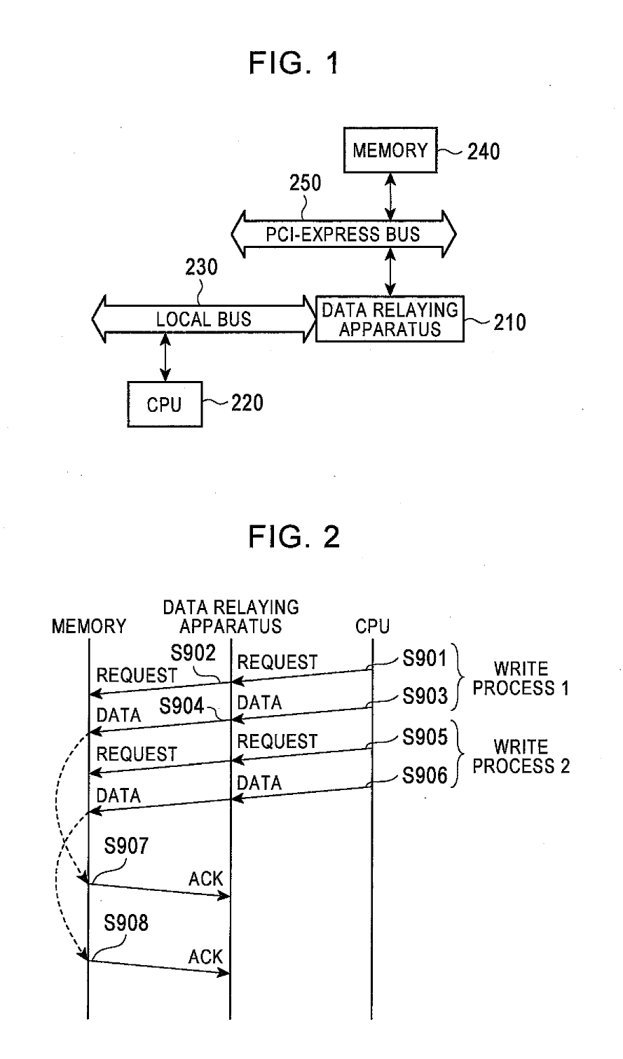

### DETAILED DESCRIPTION OF THE INVENTION

Embodiments according to the present invention will now be described in detail with reference to the accompanying drawings.

### First Embodiment

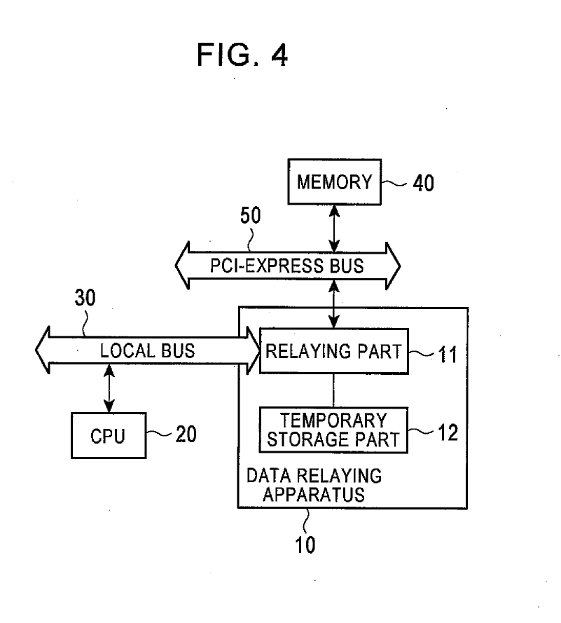

FIG. 4 is a block diagram of a data relaying apparatus 10 of this embodiment depicted along with blocks of CPU (data processing apparatus) 20 etc.

The data relaying apparatus 10 is a relaying apparatus such as a hub that relays data transmitted/received between a CPU 20 and a memory (storage apparatus) 40 via a local bus (first data bus) 30 and a PCI-Express bus (second data bus) 50. The data relaying apparatus 10 relays data via the local bus 30 to/from the CPU 20 and relays data via the PCI-Express bus 50 to/from the memory 40. When transmitting data from the local bus 30 to the PCI-Express bus 50, the data relaying apparatus 10 converts the data from the local bus 30 into a packet and transmits the packet to the PCI-Express bus 50. The data relaying apparatus 10 includes a relaying part 11 and a temporary storage part 12.

The relaying part 11 relays data transmitted/received between the CPU 20 and the memory (storage apparatus) 40 and is made up of a microprocessor, for example. The temporary storage part 12 is a memory such as a RAM that temporarily stores read data acquired by the relaying part 11 from the memory 40 via the PCI-Express bus 50.

Specifically, when receiving a data write request (hereinafter, simply, a write request), a data read request (hereinafter, simply, a read request), or write data via the local bus 30 from the CPU 20, the relaying part 11 converts the request or data into a packet and transmits the packet through the PCI-Express bus 50 to the memory 40. When receiving read data via the PCI-Express bus 50 from the memory 40, the relaying part 11 temporarily stores the data into the temporary storage part 12 and subsequently takes out and transmits the data via the local bus 30 to the CPU 20.

The CPU 20 is a data processing apparatus that acquires data from the memory 40 to perform an arithmetic process etc., and that executes a data process such as storing the data acquired by performing the arithmetic process etc., into the memory 40. The CPU 20 is connected to the local bus 30. The CPU 20 issues a write request and a read request in accordance with the progress of a data process. For example, if the local bus 30 is AHB (advanced high-performance bus), the CPU 20 issues a write or read request command of any one type of SINGLE (4 bytes), INC4 (16 bytes), INC8 (32 bytes), and INC16 (64 bytes).

The memory 40 is a storage medium such as a hard disc that stores data from the CPU 20 and other various data. The memory 40 is connected to the PCI-Express bus 50.

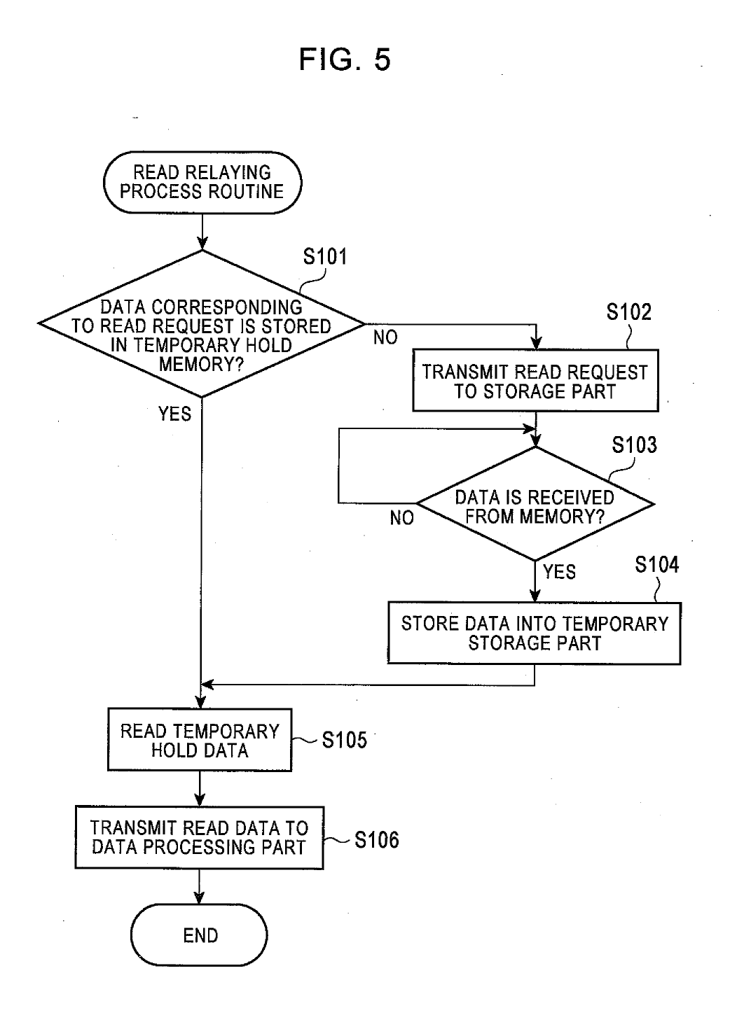

FIG. 5 is a flowchart of a read relaying process routine by the data relaying apparatus 10. A read relaying process by the data relaying apparatus 10 will hereinafter be described with reference to FIG. 5.

When receiving a read request from the CPU 20, the relaying part 11 determines whether read data corresponding to the read request is stored in the temporary storage part 12 (step S101).

If the relaying part 11 refers to the temporary storage part 12 and determines that the corresponding read data is not stored in the temporary storage part 12, the relaying part 11 transmits a read request to the memory 40 (step S102). Specifically, the relaying part 11 transmits to the memory 40 a read request indicating that data of a predetermined read ahead data size should be read out from a top address indicated by the read request from the CPU 20. The read ahead data size is a data size, for example, 256 bytes, and is set in advance in the relaying part 11. For example, if the top address indicated by the read request is 0000, the relaying part 11 transmits to the memory 40 a read request for data of a data size of 256 bytes from the address 0000. The read request is transmitted through a packet signal. In this way, the relaying part 11 converts the read request from the CPU 20 into a packet and transmits the packet to the memory 40.

After transmitting a read request, the relaying part 11 waits for the arrival of the read data corresponding to the read request from the memory 40 (S103). When receiving the read data from the memory 40, the relaying part 11 stores the read data into the temporary storage part 12 (S104). The relaying part 11 receives the read data through a packet signal. The data stored in the temporary storage part 12 and corresponding to the read request will hereinafter be referred to as temporary storage data.

The relaying part 11 then reads out data of a transmission data size corresponding to a type of the read request from the top position of the temporary storage data stored in the temporary storage part 12 (S105). For example, if the local bus 30 is AHB and the type of the read request is INC16 (64 bytes), the relaying part 11 reads data of 64 bytes from the top position of the temporary storage data.

If the relaying part 11 determines that the corresponding read data is stored in the temporary storage part 12 at step S101, the routine directly goes to the process of step S105 to execute the same process as described above.

The relaying part 11 transmits the data read out from the temporary storage part 12 via the local bus 30 to the CPU 20 (S106). The relaying part 11 executes the read relaying process routine each time a read request is made.

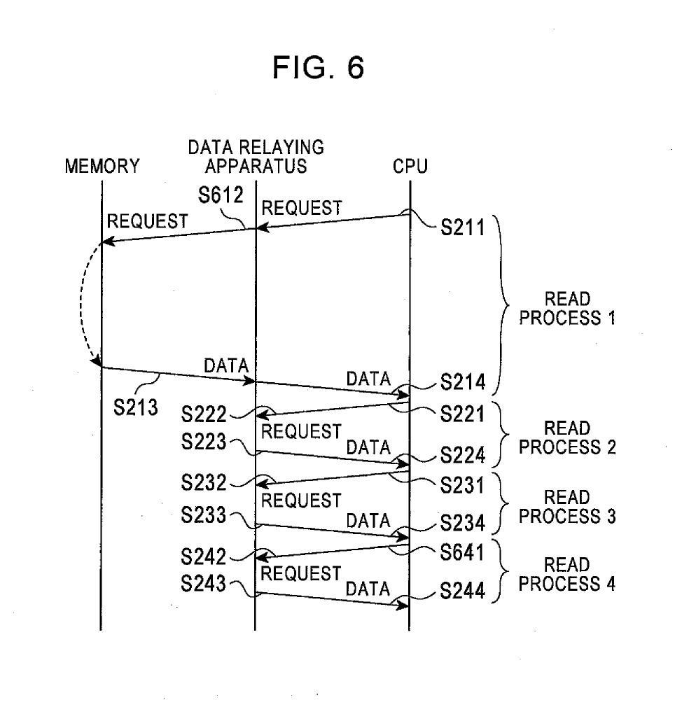

FIG. 6 is a sequence diagram of data transmission/reception in the read relaying process. The read relaying process by the data relaying apparatus 10 will hereinafter be described with reference to FIG. 6. It is assumed that the read ahead data size is set to 256 bytes in advance in the relaying part 11. It is also assumed that the local bus 30 is AHB and that the type of read requests from the CPU 20 is INC16 (64 bytes).

First, the CPU 20 transmits a read request (“REQUEST” of FIG. 6) (step S211) and the data relaying apparatus 10 receives the read request via the local bus 30.

The data relaying apparatus 10 refers to the temporary storage part 12 to determine whether the read data corresponding to the read request is stored in the temporary storage part 12 (step S101 of FIG. 5). Since the read request is a first request, the data relaying apparatus 10 determines that the corresponding read data is not stored in the temporary storage part 12 and transmits a read request to the memory 40 (step S212, step S102 of FIG. 5). Specifically, the data relaying apparatus 10 transmits to the memory 40 a read request indicating that data of the predetermined read ahead data size 256 bytes should be read out from a top address indicated by the read request from the CPU 20. The data relaying apparatus 10 then waits for the arrival of the read data from the memory 40 (step S103 of FIG. 5).

When receiving the read data of the data size of 256 bytes corresponding to the read request from the memory 40, the data relaying apparatus 10 stores the read data into the temporary storage part 12 as the temporary storage data (step S104 of FIG. 5).

The data relaying apparatus 10 reads out data of the transmission data size of 64 bytes corresponding to the read request type INC16 from the top position of the temporary storage data stored in the temporary storage part 12 (S105 of FIG. 5) and transmits the data to the CPU 20 (S213, S106 of FIG. 5). The CPU 20 receives the read data of the data size of 64 bytes (S214).

The CPU 20 subsequently transmits a subsequent read request of INC16 (64 bytes) to the data relaying apparatus 10 (S221). The data relaying apparatus 10 receives the read request via the local bus 30 (S222). Since the data relaying apparatus 10 has acquired the 256-byte read data at step 213 and has transmitted the 64-byte read data thereof, the temporary storage data of the data size of 192 bytes is stored in the temporary storage part 12 at this point.

If the data relaying apparatus 10 refers to the temporary storage part 12 and determines that the read data corresponding to the read request is stored in the temporary storage part 12, the data relaying apparatus 10 reads data of the transmission data size of 64 bytes corresponding to the read request type INC16 from the top position of the temporary storage data stored in the temporary storage part 12 and transmits the data to the CPU 20 (S223). The CPU 20 receives the read data of the data size of 64 bytes (S224). Therefore, in the read process 2 (S221 to S224), unlike the read process 1 (S211 to S214), the data relaying apparatus 10 transmits the read data to the CPU 20 without transmitting a read request to the memory 40.

If the CPU 20 subsequently transmits a subsequent read request of INC16 (64 bytes) to the data relaying apparatus 10, the data relaying apparatus 10 executes the same process as described above (a read process 3 (S231 to S234), a read process 4 (S241 to S244)). In this way, the data relaying apparatus 10 can transmit continuous data of the read ahead data size of 256 bytes to the CPU 20 without accessing the memory 40.

As described above, when receiving a read request from the CPU 20, the data relaying apparatus 10 of this embodiment acquires data of a predetermined read-ahead size from the memory 40 from the top address indicated by the read request. The data relaying apparatus 10 stores the data into the temporary storage part 12 as the temporary storage data, reads out data of a data size corresponding to a read request from the top position of the temporary storage data each time the CPU 20 makes a read request, and relays the data to the CPU 20.

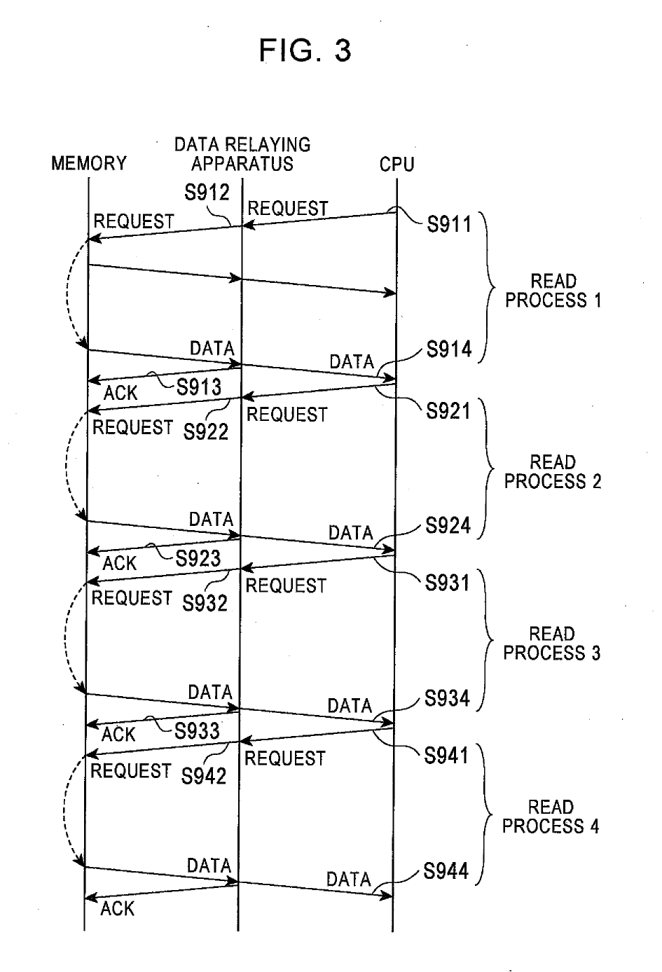

With this configuration, when the CPU 20 makes a read request for continuous read data for the second time or later, the data relaying apparatus 10 can transmit the read data corresponding to the read request to the CPU 20 without transmitting a read request to the memory 40. For example, assuming that a read data size of one read process in the conventional example depicted in FIG. 3 is set to 64 bytes and that a time required for reading the read data is 1dt, four read times 4dt are required for reading data of 256 bytes. In contrast, the data relaying apparatus 10 of this embodiment only requires a read time on the order of 1dt even when transmitting data of 256 bytes to the CPU 20 as depicted in FIG. 6 and, therefore, the time can be shortened by 3dt as compared to conventional apparatuses. Since the temporary storage part 12 is a cache memory such as RAM and the data read time thereof is drastically smaller than a time period of 1dt, a transmission time of the read data from the data relaying apparatus 10 to the CPU 20 is negligible after the read process 2.

Therefore, the data relaying apparatus 10 of this embodiment can considerably improve a data read process speed as compared to a conventional case and relay data in a highly efficient manner even in the communication form including the apparatus on the read request side (the data relaying apparatus 10) that receives data corresponding to a read request before issuing a read request for subsequent data.

### Second Embodiment

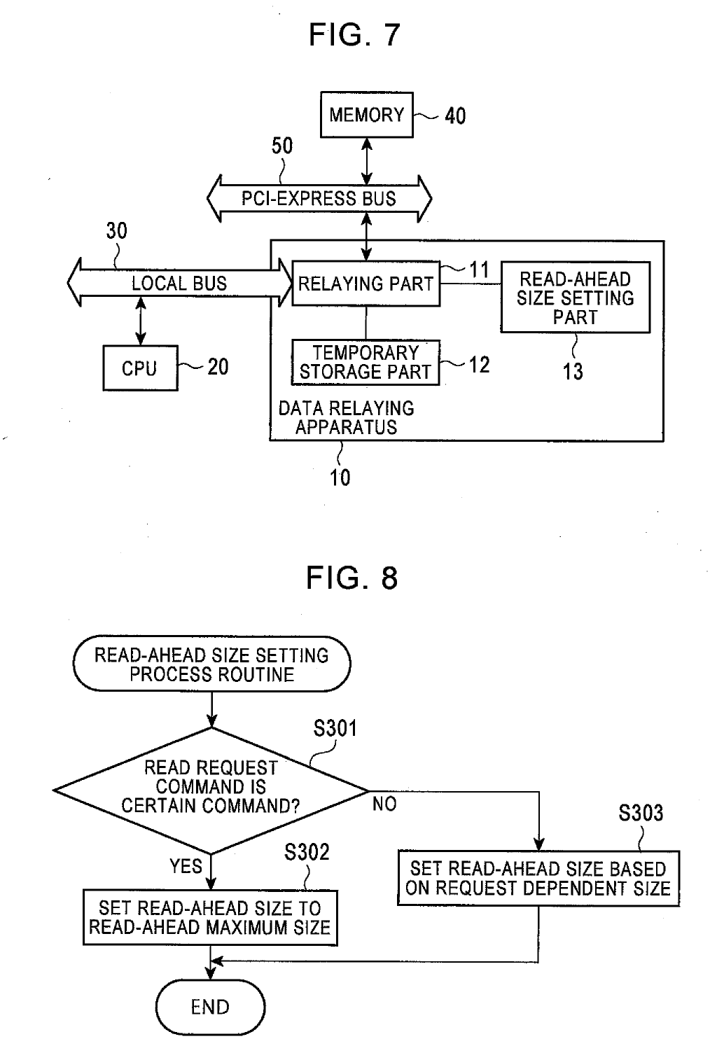

FIG. 7 is a block diagram of the data relaying apparatus 10 of this embodiment depicted along with blocks of the CPU 20 etc. Differences from the first embodiment will hereinafter mainly be described.

The data relaying apparatus 10 of this embodiment further includes a read-ahead size setting part 13. The read-ahead size setting part 13 sets a read-ahead size based on a type of a read request from the CPU 20 and is made up of a microprocessor, for example.

FIG. 8 is a flowchart of a read-ahead size setting process routine by the read-ahead size setting part 13. The read-ahead size setting process routine is a routine executed between steps S101 and S102 of the read relaying process routine depicted in FIG. 5. The read-ahead size setting process will hereinafter be described with reference to FIG. 8 on the basis that the local bus 30 is AHB and that a read request from the CPU 20 is of any one type of SINGLE (4 bytes), INC4 (16 bytes), INC8 (32 bytes), and INC16 (64 bytes).

The read-ahead size setting part 13 determines whether a type of a read request received by the relaying part 11 is INC16 (64 bytes) (step S301). INC16 is a command for requesting the maximum data size among data sizes that may be requested for write/read in AHB and is issued from the CPU 20 when 64-byte or more data is read out.

If determining that the type of the read request is INC16 (64 bytes), the read-ahead size setting part 13 sets the read-ahead size to a read-ahead maximum size (step S302). The read-ahead maximum size is the maximum data size to be set as the read-ahead size and is set to, for example, 256 bytes in advance in the read-ahead size setting part 13 if it is known that 256-byte data is frequently relayed, for example.

If determining that the type of the read request is not INC16 (64 bytes), i.e., the type is any one of SINGLE (4 bytes), INC4 (16 bytes), and INC8 (32 bytes), the read-ahead size setting part 13 sets the read-ahead size based on a request dependent size (step S303). The request dependent size is a size corresponding to a read ahead request, i.e., a data size of 4 bytes in the case of SINGLE, 16 bytes in the case of INC4, or 32 bytes in the case of INC8. The read-ahead size setting part 13 sets the read-ahead size to a data size acquired by, for example, doubling the request dependent size, i.e., 8 bytes in the case of SINGLE, 32 bytes in the case of INC4, or 64 bytes in the case of INC8. For example, since INC8 is a request issued when data of a size of 32 to 64 bytes is read out, it is sufficient to preliminarily read the data of a size of 64 bytes, i.e., the double of 32 bytes and, therefore, a size twice as large as the request dependent size is set as the read-ahead size.

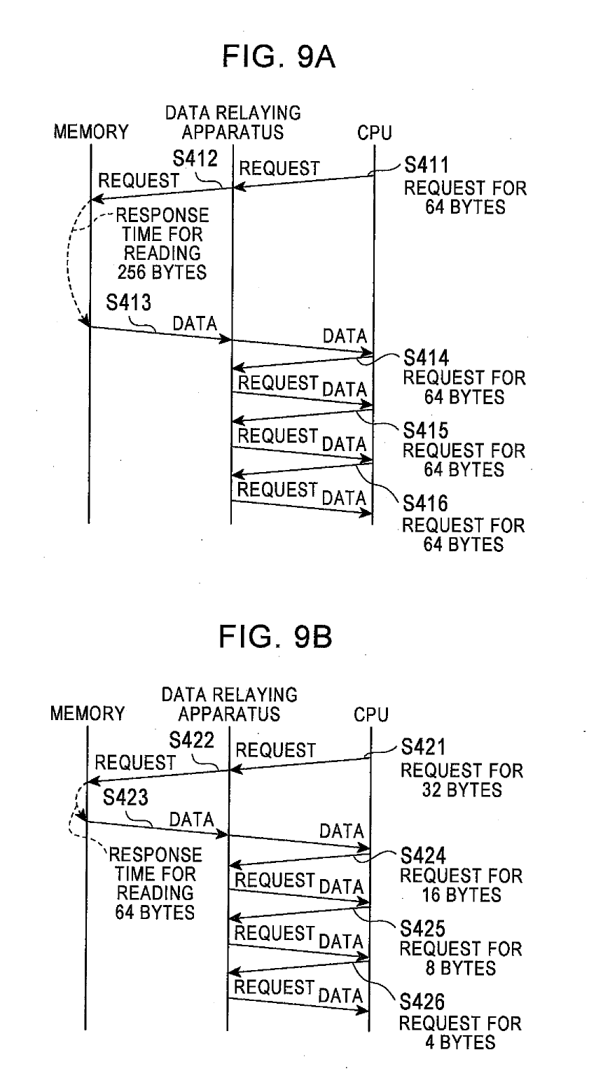

FIG. 9A is a sequence diagram of data transmission/reception in the read relaying process when a read-ahead size is set to the read-ahead maximum size in the read-ahead size setting process routine. The process in the case of reading 256-byte data by the CPU 20 will hereinafter be described as an example.

The CPU 20 transmits a read request of INC16 (64 bytes) (step S411) and the relaying part 11 of the data relaying apparatus 10 receives the read request. The read-ahead size setting part 13 determines that the read request is INC16, sets the read-ahead size to the read-ahead maximum size of 256 bytes, and transmits a read request to the memory 40 (S412).

The memory 40 reads out data of 256 bytes from the top address indicated by the read request and transmits the data to the data relaying apparatus 10. The relaying part 11 receives the read data of 256 bytes and the temporary storage part 12 temporarily stores the data as the temporary storage data (S413). The relaying part 11 transmits data of 64 bytes from the top of the temporary storage data stored in the temporary storage part 12 to the CPU 20 and the CPU 20 receives the data (S414).

The relaying part 11 sequentially transmits data of 64 bytes from the top of the temporary storage data stored in the temporary storage part 12 to the CPU 20 in response to a subsequent read request of INC 16 transmitted from the CPU 20 (S414 to S416).

As described above, if a read request of INC16 (64 bytes) is received from the CPU 20, data of the read-ahead maximum size of 256 bytes is acquired from the memory 40 and temporarily stored in the temporary storage part 12 and, therefore, it is not necessary to make a read request to the memory 40 for each subsequent read request from the CPU 20 and the data read time can be shortened.

FIG. 9B is a sequence diagram of data transmission/reception in the read relaying process when a read-ahead size is set in accordance with a request dependent size in the same routine. The process in the case of reading 60-byte data by the CPU 20 will hereinafter be described as an example.

The CPU 20 transmits a read request of INC8 (32 bytes) (step S421) and the relaying part 11 of the data relaying apparatus 10 receives the read request. The read-ahead size setting part 13 determines that the read request is INC16, sets the read-ahead size to 64 bytes twice as large as 32 bytes of the request dependent size, and transmits a read request to the memory 40 (S422).

The memory 40 reads out data of 64 bytes from the top address indicated by the read request and transmits the data to the data relaying apparatus 10. The relaying part 11 receives the read data of 64 bytes and the temporary storage part 12 temporarily stores the data as the temporary storage data (S423). The relaying part 11 transmits data of 32 bytes from the top of the temporary storage data stored in the temporary storage part 12 to the CPU 20 and the CPU 20 receives the data (S424).

The relaying part 11 sequentially transmits data of 16 bytes, 8 bytes, and 4 bytes from the top of the temporary storage data stored in the temporary storage part 12 to the CPU 20 in response to subsequent read requests of INC4 etc., transmitted from the CPU 20 (S424 to S426).

As described above, if a read request of INC8 (32 bytes) is received from the CPU 20, data of 64 bytes twice as large as 32 bytes of the request dependent size is acquired from the memory 40 and temporarily stored in the temporary storage part 12 and, therefore, it is not necessary to make a read request to the memory 40 for each subsequent read request from the CPU 20 and a data acquisition time (indicated by a dotted line) from the memory 40 can be reduced to shorten the data read time.

As described above, the data relaying apparatus 10 of this embodiment further includes the read-ahead size setting part 13 that sets the read-ahead size based on a type of a read request from the CPU 20. Since data of an appropriate size can be acquired from the memory 40 through the process by the read-ahead size setting part 13 described above, the data read time can be shortened.

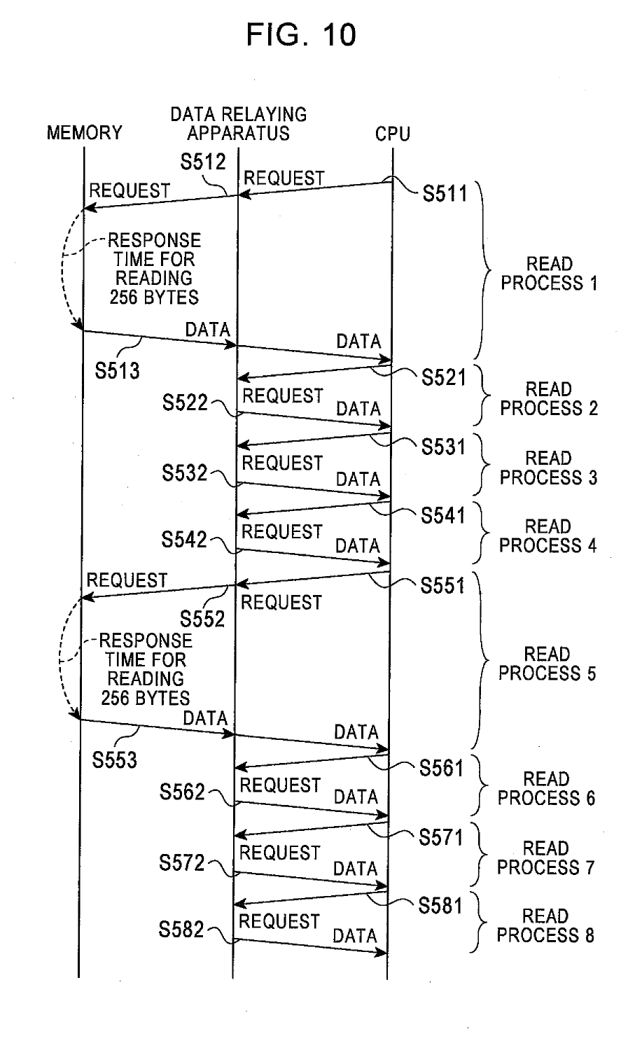

FIG. 10 is a sequence diagram of data transmission/reception in the read relaying process when the CPU 20 reads out data of 512 bytes in the case of the read-ahead maximum size set to 256 bytes.

In this case, the CPU 20 transmits INC16, which is a command for requesting 64 bytes, i.e., the maximum data size among data sizes that may be requested for read in AHB, to the data relaying apparatus 10 a total of eight times (steps S511, S521, . . . , S581). In response to a first read request (S511), the data relaying apparatus 10 first transmits a read request for data of the read maximum size of 256 bytes to the memory 40 (step S512). The data relaying apparatus 10 temporarily stores the 256-byte read data from the memory 40 as the temporary storage data into the temporary storage part 12 and transmits data of 64 bytes from the top of the temporary storage data to the CPU 20 (S513). In response to second to fourth read requests (S521, S531, S541), the data relaying apparatus 10 sequentially transmits data of 64 bytes from the top of the temporary storage data to the CPU 20 (S522, S532, S542). All the temporary storage data stored in the temporary storage part 12 are transmitted through these transmissions.

In response to a fifth read request (S551), the data relaying apparatus 10 transmits a read request for data of the read maximum size of 256 bytes to the memory 40 (step S552). The data relaying apparatus 10 temporarily stores the 256-byte data from the memory 40 as the temporary storage data into the temporary storage part 12 and transmits data of 64 bytes from the top of the temporary storage data to the CPU 20 (S553). In response to sixth to eighth read requests (S561, S571, S581), the data relaying apparatus 10 sequentially transmits data of 64 bytes from the top of the temporary storage data to the CPU 20 (S562, S572, S582).

With this data relaying process, the read time can considerably be shortened in the case of relaying 512-byte data. Assuming that the CPU 20 requires a time period of 1dt after transmitting the first read request to receive the read data corresponding to the request, a time required for the CPU 20 to acquire the 512-byte data is on the order of 2dt.

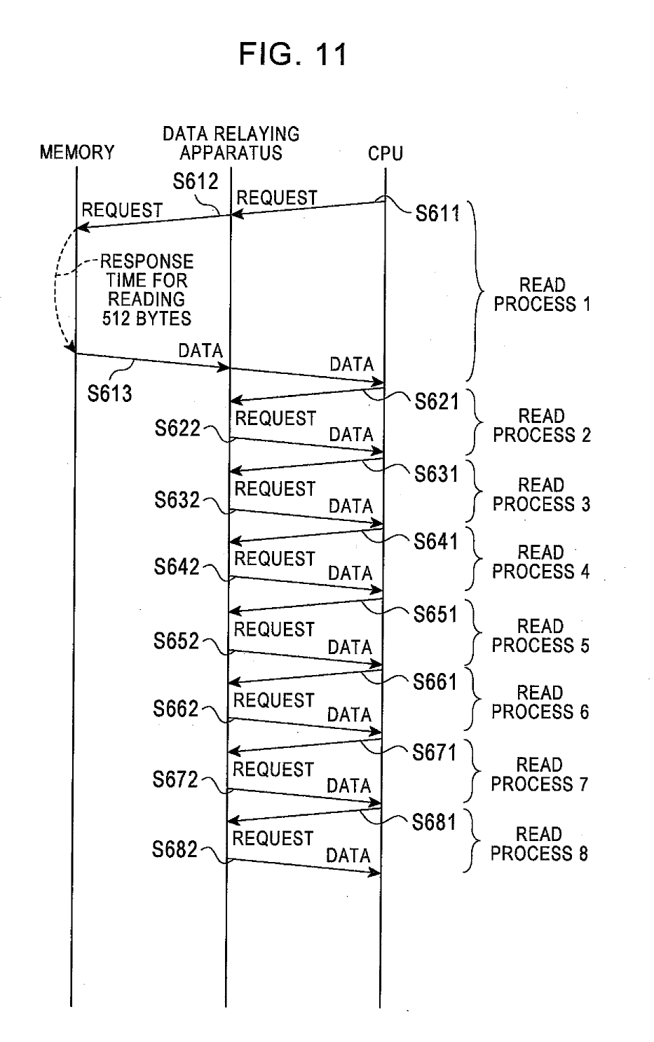

FIG. 11 is a sequence diagram of data transmission/reception in the read relaying process when the CPU 20 reads out 512-byte data in the case of the read-ahead maximum size set to 512 bytes.

In this case, the CPU 20 transmits INC16, which is a command for requesting 64 bytes, i.e., the maximum data size among data sizes that may be requested for read in AHB, to the data relaying apparatus 10 a total of eight times (steps S611, S621, . . . , S681). In response to a first read request (S611), the data relaying apparatus 10 first transmits a read request for data of the read maximum size of 512 bytes to the memory 40 (step S612). The data relaying apparatus 10 temporarily stores the 512-byte read data from the memory 40 as the temporary storage data into the temporary storage part 12 and transmits data of 64 bytes from the top of the temporary storage data to the CPU 20 (S613). In response to second to eighth read requests (S621, S631, . . . , S681), the data relaying apparatus 10 sequentially transmits data of 64 bytes from the top of the temporary storage data to the CPU 20 (S622, S632, . . . , S682).

As described above, when the read-ahead maximum size is set to 512 bytes, a time required for the CPU 20 to acquire the 512-byte data is on the order of 1dt. As compared to the case that the read-ahead maximum size is set to 256 bytes, the read time can further be shortened by about 1dt.

### Third Embodiment

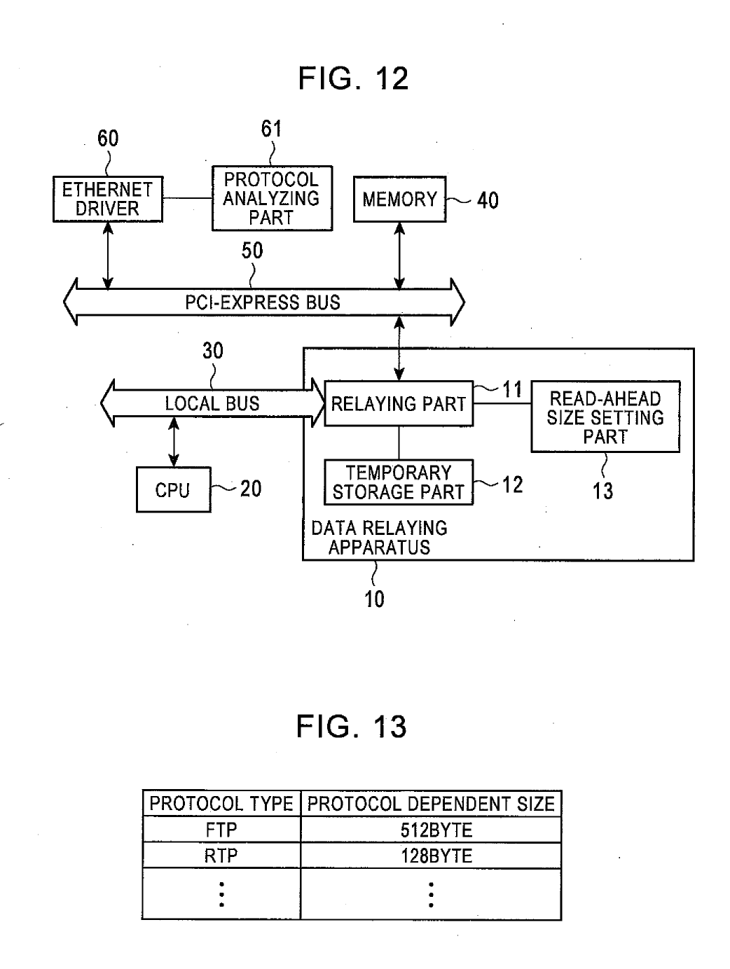

FIG. 12 is a block diagram of the data relaying apparatus 10 of this embodiment depicted along with blocks of CPU 20 etc. Differences from the second embodiment will hereinafter mainly be described.

The read-ahead size setting part 13 of this embodiment sets the read-ahead maximum size based on a type of a communication protocol. The PCI-Express bus 50 is connected to an Ethernet driver (transmitting part) 60 that transmits data in the memory 40. Ethernet is a registered trademark. A protocol analyzing part 61 performs the Ethernet protocol analysis of data transmitted by the Ethernet driver 60 to determine the type of the communication protocol. The protocol analyzing part 61 may perform the protocol analysis each time the Ethernet driver 60 transmits data or may perform the protocol analysis every few times of data transmissions. Types of communication protocols include FTP (File Transfer Protocol) and RTP (Real-time Transport Protocol), for example. The communication protocol type information acquired from the analysis by the protocol analyzing part 61 is transmitted by the Ethernet driver 60 via the PCI-Express bus 50 to the data relaying apparatus 10.

The read-ahead size setting part 13 receives the communication protocol type information from the Ethernet driver 60 via the PCI-Express bus 50 and sets the read-ahead maximum size depending on the type. FIG. 13 is a diagram of a size correlation table representing the correlation between a protocol type and a read ahead data size. The read-ahead size setting part 13 retains the size correlation table in advance. In this case, a protocol type FTP is correlated with a protocol dependent size of 512 bytes and a protocol type RTP is correlated with a protocol dependent size of 128 bytes.

The communication protocol FTP is mainly used for data uploading/downloading applications for an apparatus such as a server (not depicted). Therefore, a data size of a communication object is relatively large and, for example, the read-ahead maximum size is set to a relatively large size such as 512 bytes in the case of FTP. The communication protocol RTP is mainly used for transmission/reception of audio data of VoIP (Voice over Internet Protocol). Therefore, a data size of a communication object is relatively small and, for example, the read-ahead maximum size is set to a relatively small size such as 128 bytes in the case of RTP.

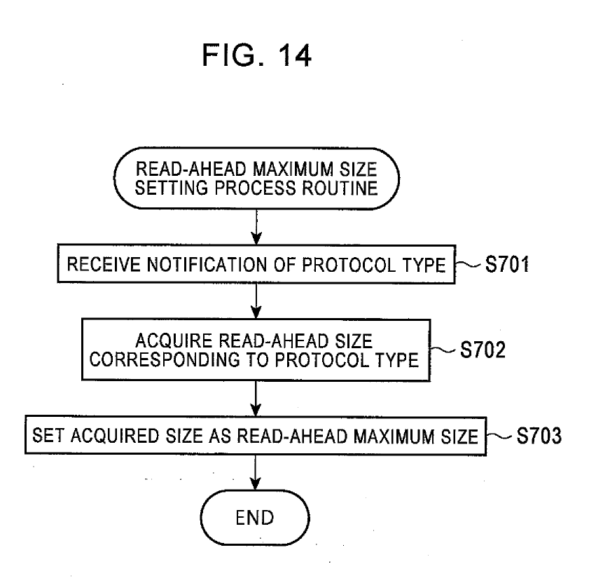

FIG. 14 is a flowchart of a read-ahead maximum size setting process routine by the read-ahead size setting part 13. The read-ahead maximum size setting process will hereinafter be described with reference to FIG. 14.

When receiving the communication protocol type information from the Ethernet driver 60 via the PCI-Express bus 50 (step S701), the read-ahead size setting part 13 acquires a data size (protocol dependent size) corresponding to a protocol type indicated by the type information from the size correlation table (S702). For example, if the protocol type is FTP, the protocol dependent size of 512 bytes is acquired from the size correlation table (FIG. 10). The read-ahead size setting part 13 then sets the acquired protocol dependent size of 512 bytes as the read-ahead maximum size (S703).

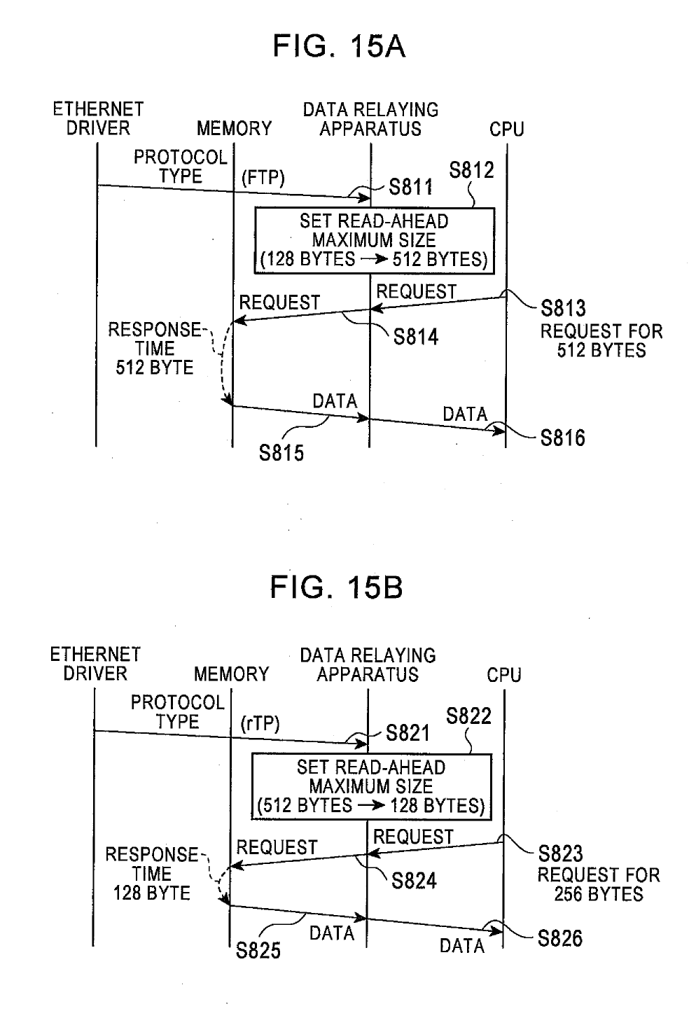

FIG. 15A is a sequence diagram of data transmission/reception in the read relaying process when an acquisition size larger than a currently set size is set as the read-ahead maximum size in the read-ahead size setting process routine. Description will be made on the basis that the read-ahead size setting part 13 has the read-ahead maximum size of 128 bytes as the currently set size.

When the relaying part 11 of the data relaying apparatus 10 receives the protocol type information from the Ethernet driver 60 (step S811), the read-ahead size setting part 13 sets the read maximum size (S812). If the protocol type information indicates, for example, FTP, the read-ahead size setting part 13 refers to the size correlation table (FIG. 13) and sets the read maximum size to 512 bytes. The read maximum size is changed from 128 bytes to 512 bytes.

The CPU 20 subsequently transmits a read request of a read data size of 512 bytes to the data relaying apparatus 10 (S813). When the read request is received, the relaying part 11 transmits a read request of the read maximum size of 512 bytes to the memory 40 (S814). The relaying part 11 receives the read data of 512 bytes from the memory 40, temporarily stores the data as the temporary storage data into the temporary storage part 12, and transmits the data of 512 bytes from the top of the temporary storage data (i.e., all the data) to the CPU 20 (S815).

By predicting a data size of a read request based on a protocol type and setting the size as the read-ahead maximum size as described above, the data relaying apparatus 10 can transmit a read request to the memory 40 only once to acquire all the read request data. Although a read request for 128 bytes is transmitted four times to the memory 40 to acquire data of 512 bytes in the conventional case, the data relaying apparatus 10 of this embodiment needs to transmit a read request only once to the memory 40 and thus can considerably shorten the time of reading data from the memory 40.

FIG. 15B is a sequence diagram of data transmission/reception in the read relaying process when an acquisition size smaller than a currently set size is set as the read-ahead maximum size in the same routine. Description will be made on the basis that the read-ahead size setting part 13 has the read-ahead maximum size of 512 bytes as the currently set size.

When the relaying part 11 of the data relaying apparatus 10 receives the protocol type information from the Ethernet driver 60 (step S821), the read-ahead size setting part 13 sets the read maximum size (S822). If the protocol type information indicates, for example, RTP, the read-ahead size setting part 13 refers to the size correlation table (FIG. 13) and sets the read maximum size to 128 bytes. The read maximum size is changed from 512 bytes to 128 bytes.

The CPU 20 subsequently transmits a read request of a read data size of 128 bytes to the data relaying apparatus 10 (S823). When the read request is received, the relaying part 11 transmits a read request of the read maximum size of 128 bytes to the memory 40 (S824). The relaying part 11 receives the read data of 128 bytes from the memory 40, temporarily stores the data as the temporary storage data into the temporary storage part 12, and transmits the data of 128 bytes from the top of the temporary storage data (i.e., all the data) to the CPU 20 (S825).

As described above, the data relaying apparatus 10 requests a read data of an appropriate size to the memory 40. Although a read request for 512 bytes is transmitted to the memory 40 in the conventional case, since the data relaying apparatus 10 of this embodiment transmits a read request for 128 bytes to the memory 40, the read data amount is reduced and the time of reading data from the memory 40 can considerably be shortened.

This embodiment is an example of the case that the protocol analyzing part is disposed on the outside of the data relaying apparatus 10, the protocol analyzing part may be disposed inside the data relaying apparatus 10. The protocol analyzing part 61 may have the size correspondence table (FIG. 13) and determine a protocol dependent size from the size correspondence table depending on the analysis result and the Ethernet driver 60 may transmit the protocol correspondence size to the data relaying apparatus 10. In this case, the read-ahead size setting part 13 sets the received protocol dependent size as the read-ahead size. This configuration achieves the same effect as the third embodiment.

Although the first to third embodiments are examples of the case that the second data bus is a PCI-Express bus, the data relaying apparatus of the present invention is applicable to the communication form that an apparatus on the read request side receives data corresponding to a read request before issuing a read request for subsequent data.

This application is based on Japanese Patent Application No. 2010-046704 which is herein incorporated by reference.

What is claimed is:

1. A data relaying apparatus having a relaying part that acquires data stored in a storage apparatus via a second data bus in response to a data read request arriving from a data processing apparatus via a first data bus to relay the data to the data processing apparatus via the first data bus, comprising:
a temporary storage part that acquires data of a predetermined read-ahead size from the storage apparatus from a top address indicated by the data read request to temporarily store the data as temporary storage data, wherein
each time a subsequent data read request is made, the relaying part reads out data of a transmission data size corresponding to a type of the subsequent data read request sequentially from a top position of the temporary storage data to relay the data to the data processing apparatus.

2. The data relaying apparatus of claim 1, further comprising a read-ahead size setting part that sets the read-ahead size based on a type of the data read request.

3. The data relaying apparatus of claim 1, further comprising a read-ahead size setting part that sets the read-ahead size based on a type of a communication protocol corresponding to data stored in the storage apparatus.

4. The data relaying apparatus of claim 2, wherein the read-ahead size setting part sets the read-ahead size to a size larger than the transmission data size.

5. The data relaying apparatus of claim 3, wherein the read-ahead size setting part sets the read-ahead size to a size larger than the transmission data size.

6. A data relaying method having a relaying step of acquiring data stored in a storage apparatus via a second data bus in response to a data read request arriving from a data processing apparatus via a first data bus to relay the data to the data processing apparatus via the first data bus, comprising:
a temporary storage step of acquiring data of a predetermined read-ahead size from the storage apparatus from a top address indicated by the data read request to temporarily store the data as temporary storage data, wherein
at the relaying step, each time a data request is made, data of a transmission data size corresponding to a type of the data request is relayed sequentially from a top position of the temporary storage data to the data processing apparatus.

7. The data relaying method of claim 6, further comprising a read-ahead size setting step of setting the read-ahead size based on a type of the data read request.

8. The data relaying method of claim 6, further comprising a read-ahead size setting step of setting the read-ahead size based on a type of a communication protocol corresponding to data stored in the storage apparatus.

9. The data relaying method of claim 7, wherein at the read-ahead size setting step, the read-ahead size is set to a size larger than the transmission data size.

10. The data relaying method of claim 8, wherein at the read-ahead size setting step, the read-ahead size is set to a size larger than the transmission data size.
